(19) United States
(12) Patent Application Publication
(10) Pub. No.: US 2021/0085569 A1
(43) Pub. Date: Mar. 25, 2021

(54) FEEDING BOTTLE TEAT

(71) Applicant: Hopeful Rubber Manufacturing Co. Limited, Siu Lek Yuen (HK)

(72) Inventor: Sung Shan LI, Kowloon (HK)

(21) Appl. No.: 17/029,233

(22) Filed: Sep. 23, 2020

(30) Foreign Application Priority Data
Sep. 23, 2019 (GB) 1913681.1

(51) Int. Cl. A61J 11/00

(52) U.S. Cl. CPC A61J 11/0065; A61J 11/008

(57) ABSTRACT

A feeding bottle teat includes a body having an interior cavity and an exterior surface, an inlet including a flange for engagement within an aperture of a feeding bottle cap in use, and a nipple including one or more outlet apertures wherein the flange, cavity, nipple and apertures form a passageway for delivery of milk from the bottle in use, wherein a transverse dimension of the interior surface of the body at the inlet is greater than a transverse dimension at the nipple, and wherein the interior surface includes a plurality of concentric strengthening formations extending inwardly from the inner surface between the inlet and the nipple, wherein the strengthening formations comprise coaxial concentric spirals which rotate about a common central axis, wherein each strengthening member comprises a spiral having two to four rotations about the central axis.

### BACKGROUND OF THE INVENTION

This invention relates to a teat for a feeding device, particularly but not exclusively for a feeding bottle for milk, other beverage or drink (referred to in this specification as milk for brevity) for a baby or infant.

Conventional babies' feeding bottles are generally cylindrical with a threaded opening and having a teat with a flange which is engaged within an annular threaded cap. The teat has a relatively narrow diameter in order to maintain a stable configuration in use.

### SUMMARY OF THE INVENTION

According to the present invention a feeding bottle teat comprises:

a body having an interior cavity and an exterior surface; an inlet including a flange for engagement within an aperture of a feeding bottle cap in use, and

a nipple including one or more outlet apertures wherein the flange, cavity, nipple and apertures form a passageway for delivery of milk from the bottle in use;

wherein a transverse dimension of the interior surface of the body at the inlet is greater than a transverse dimension at the nipple; and

wherein the interior surface includes a plurality of strengthening formations located between the inlet and the nipple.

In a preferred embodiment the interior surface includes a plurality of concentric strengthening formations extending between the inlet and the nipple.

In an embodiment the strengthening formations comprise strengthening members, for example ribs, extending inwardly from the interior surface. Alternatively, or in addition the formations may comprise holes, channels in the interior surface. An array of holes may be employed. Alternatively or in addition one or more channels may be employed.

The formations may be arranged in an array extending across the interior surface of the body. The separation between adjacent formations may decrease from the distal end of the teat to the proximal end of the teat.

The separation between adjacent formations may decrease in proportion to the axial distance of the formations from the nipple.

The density of formations on the interior surface may be in inverse proportion to the thickness of the underlying wall. This may have the effect of increasing the strength and resistance to deformation of relatively thinner parts of the body.

The exterior of the body may be domed or rounded. In embodiments of the invention the exterior surface has a configuration of the shape of a mother's breast.

In a first embodiment the exterior of the body is axially symmetrical. The body may be co-axial with the flange. The body may be co-axial with a bottle in use. Alternatively the nipple may be offset from the axis of the flange. Such a configuration may better replicate the natural shape of a mother's breast.

The strengthening formations may comprise concentric spirals. The spirals may be co-axial. Alternative configurations may comprise alternating or zig-zag patterns.

The formations may be discrete or may overlap. The formations may form a regular pattern and may be symmetrical about a central axis of the body.

The strengthening formations may be independently continuous or intermittent. For example, a rib may comprise an array of projections or several shorter ribs. However continuously extending ribs may be preferred ease of manufacture, cleaning and efficiency in strengthening the body of the teat. The ribs may be parallel-sided or having a constant thickness.

Alternatively, or in addition the channels may comprise a linear array of holes or indentations. However continuously extending holes, indentations or channels may be preferred for ease of manufacture, cleaning and to provide more efficient strengthening in use.

Continuous or unbroken ribs or channels may be preferred to give greater efficiency, ease of manufacture, cleaning and durability.

A plurality of strengthening formations may comprise 2 to 5 formations, preferably 2 to 4 or more, more preferably 3. The concentric spirals may rotate about a common central axis, preferably descending through the centre of the nipple and the centre of the circular flange.

The spirals may be located symmetrically about the nipple.

Each spiral may be equally spaced from each adjacent spiral. For example, when three spirals are employed they may be separated by an angle of 120 degrees around the central axis of the teat or nipple.

The separation between adjacent strengthening members may decrease from the vicinity of the inlet towards the vicinity of the nipple. This provides for a relatively stiffer or more resilient construction adjacent the nipple.

Preferably the number of spirals is an odd number, for example three or five.

In exemplary embodiments each spiral may form two to four rotations about the central axis, preferably three rotations.

The use of an even number of spirals may be undesirable, for example by providing an increased liability for the teat to collapse on one side in use.

The use of spiral strengthening formations may provide several advantages. The formations may impart a rotation or swirling motion to the milk as it is drawn through the apertures of the nipple. Alternatively, or in addition, a rotational or swirling motion may be imparted to air bubbles drawn into the teat. Furthermore, a vortex in the milk may facilitate passage of air through the inlet and into the bottle, avoiding the development of a pressure difference between the interior and the exterior of the bottle. This may reduce liability for a baby to swallow air thereby reducing the likelihood of occurrence of colic.

In preferred embodiments a denser pattern of strengthening members may be provided at a region of the inner surface adjacent the nipple. A gradual increase in density of the strengthening members may be provided in a direction from the inlet towards the nipple. This arrangement may provide a resistance to collapse in use, for example if the teat is bitten.

Ends of each of the spiral strengthening formations or members may be equidistantly located around the inner surface adjacent the inlet and/or nipple.

The nipple may include a plurality of outlet apertures. In an embodiment two-six, preferably two to four, for example three apertures may be provided. This has the advantage of simulating the number of ducts in a mother's nipple.

The nipple may have a generally cylindrical body with a rounded end.

In an embodiment the strengthening formations may extend into the interior of the nipple body. Alternatively, the strengthening formations may not extend into the nipple body.

A plurality of projections may be provided on the external surface of the body adjacent the nipple. A circular array of projections may be provided. These may mimic a mother's Montgomery glands. For example, eight projections may be employed.

The body may include an air valve to admit air through the body into the interior of the body to release pressure caused by sucking of milk from the teat.

A teat in accordance with this invention may have a relatively large width of diameter in comparison to conventional feeding bottles, allowing the teat to have a wider configuration with a larger transverse dimension and shape which resembles the natural shape of a mother's breast. The shape and tactile properties of the teat may more closely resemble a mother's breast than is possible with conventional feeding bottle teats.

Such a configuration and properties may stimulate a baby's development.

The body of the teat may be axially symmetrical. The body be domed or conical in shape.

Alternatively the central axis of the body may be curved to provide a configuration which resembles the natural shape of a mother's breast.

Use of a larger diameter flange and wider body in comparison to conventional teats facilitates cleaning, for example to remove residues of cold milk powder.

The increased strength of the teat allows use of a relatively soft polymeric material without having a liability to collapse in use. The construction of a teat in accordance with the invention may allow the thickness of the body to be reduced to improve softness of the teat.

### BRIEF DESCRIPTION OF THE DRAWINGS

The invention is further described by means of example but not in any limitative sense with reference to the accompanying drawings, of which:

FIGS. 1(a, b, c and d) show front and side elevations, a plan view and a cross-sectional view of a first teat in accordance with this invention;

FIGS. 2(a and b) are a plan view and enlarged detail of the teat shown in FIG. 1;

FIGS. 3(a and b) are a cross-sectional view and enlarged detail of the teat shown in FIGS. 1 and 2;

FIGS. 4(a, b, c and d) show front and side elevations, a plan view and a cross-sectional view of a second teat in accordance with this invention;

FIGS. 5(a and b) are a plan view and enlarged detail of the teat shown in FIG. 4;

FIGS. 6(a and b) are a cross-sectional view and enlarged detail of the teat shown in FIGS. 4 and 5;

FIGS. 7(a, b, c and d) show front and side elevations, a plan view and a cross-sectional view of a first teat in accordance with this invention;

FIGS. 8(a and b) are a plan view and enlarged detail of the teat shown in FIG. 7;

FIGS. 9(a and b) are a cross-sectional view and enlarged detail of the teat shown in FIGS. 7 and 8; and

FIGS. 10(a and b) are a cross-sectional view of a further teat.

FIGS. 11(a and b) are a view from underneath and a cross sectional view of a further teat;

FIGS. 12(a and b) are a view from underneath and a cross sectional view of a further teat;

FIGS. 13(a and b) are a view from underneath and a cross sectional view of a further teat; and

FIGS. 14(a and b) are a view from underneath and a cross sectional view of a further teat.

### DETAILED DESCRIPTION OF THE PREFERRED EMBODIMENTS

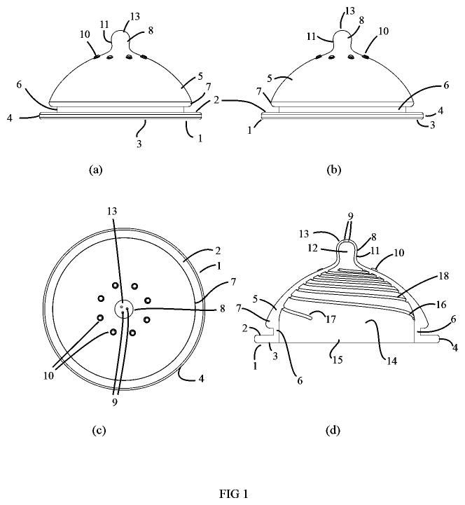

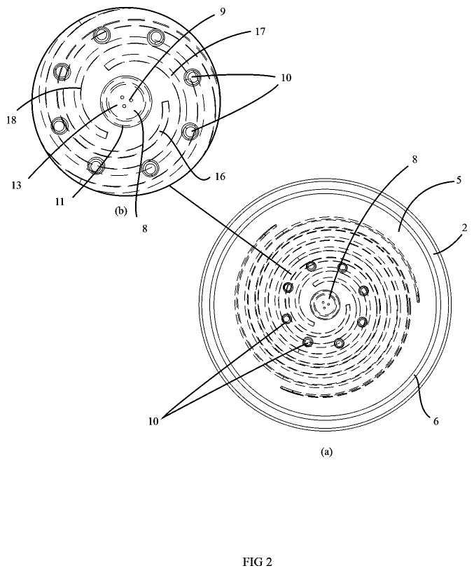

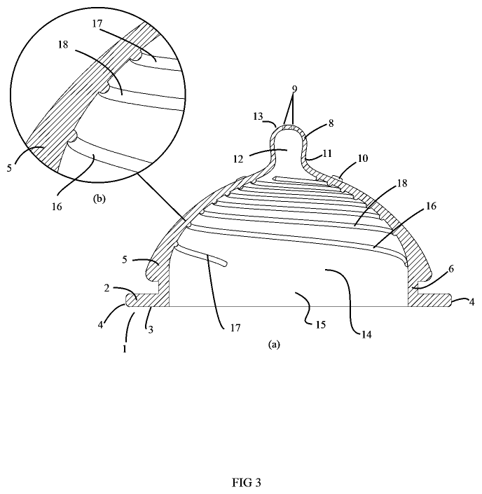

FIGS. 1(a-d), FIGS. 2(a-b) and FIGS. 3(a-b) show a first teat in accordance with this invention. An annular flange (1) has upper (2) and lower (3) surfaces. A cylindrical outer surface (4) extends from the lower portion of a smaller diameter cylindrical formation (6) located on a lower part (7) of the teat body (5).

The lower part (7) of the body (5) has a greater diameter than the cylindrical formation (6), so that the upper surface (2), cylindrical formation (6) and lower part (7) of the body define a cylindrical annular channel configured to be received in the annular orifice of a cap of a baby's feeding bottle, with the edge of the orifice securely located in the cylindrical annular channel. The teat is composed of resilient elastomeric or polymeric material. This allows the teat to be deformed to fit into the aperture in a bottle cap, forming a liquid-tight seal and securely engaging the teat onto the bottle cap. The cap has a greater diameter than a conventional baby's feeding bottle to accommodate the larger diameter of the teat.

The body (5) has an axially-symmetrical, domed exterior surface configured to resemble the shape of a mother's breast.

A nipple (8) is located axially of the teat, centrally on top of the body (5).

A circular array of eight projections (10) are located around the nipple (8) and extend upwardly from the body (5) to mimic the Montgomery Glands of a natural breast.

The nipple comprises a generally cylindrical body (11) having a hollow interior (12) and a domed top (13). A plurality of outlet ducts (9) extend through the domed top (13). In the depicted embodiment three ducts are shown.

The interior (14) of the body (5) has a maximum diameter at the inlet defined by the lower part (7) of the body. The diameter decreases in an upward direction towards the nipple located at the upper part of the teat. The thickness of the wall of the body decreases from the inlet towards the nipple, allowing the softness and flexibility of the teat to increase towards the nipple region.

Three concentric strengthening members extend into the interior (14) in a spiral configuration from the inner surface of the body (5).

The arrangement of the strengthening members is shown in detail in FIGS. 2a and b which show a view from above. FIG. 2b is a partially enlarged view of FIG. 2a. The strengthening members are also shown in FIGS. 3a and b. FIG. 3a is a cross-sectional view and FIG. 3b shows an enlarged detail of FIG. 3a.

The three strengthening members comprise projections (16), (17) and (18) extending into the interior (14) of the teat from the inner surface of the body.

The projections (16), (17) and (18) each comprise elongate rounded ribs having a first lower end adjacent the lower part (7) of the body and a second upper end adjacent the nipple (8). The three projections are equidistantly spaced around the central axis of the teat, the central axis extending from the nipple (8) to the lower part (7) of the lower body (5). In this embodiment the central axis extends vertically orthogonal to the plane of the flange (1), (2), (4).

The separation between adjacent projections reduces as the distance of the projections from the nipple decreases, as shown in greater detail in FIGS. 3a and b.

This configuration enables the thickness of the body to be reduced towards the nipple while maintaining sufficient stiffness to prevent collapse of the teat in use.

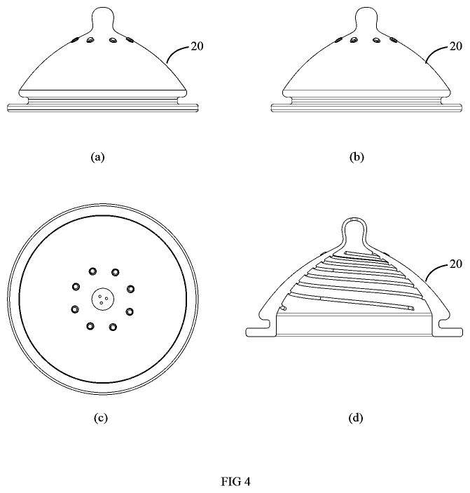

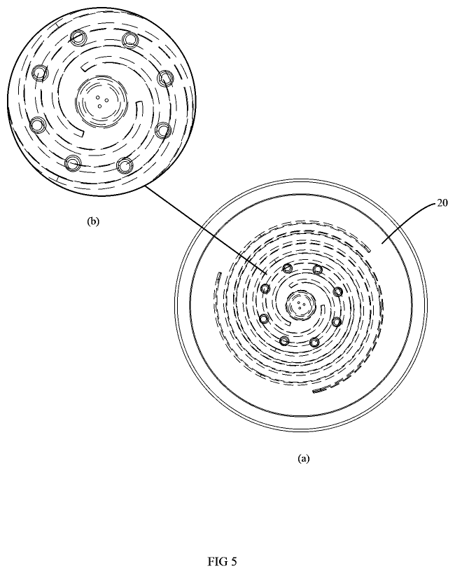

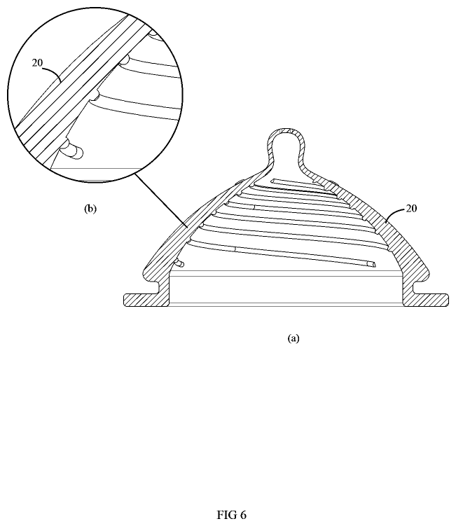

FIGS. 4(a-d), FIGS. 5(a-b) and FIGS. 6(a-b) show a second teat in accordance with this invention. The construction of the teat is similar to that shown in FIGS. 1 to 3 with the exception that exterior surface (20) of the body has a rounded conical shape in comparison to the embodiment of FIGS. 1 to 3. The walls have a greater radius in curvature in cross-section as shown in FIG. 4d. Alternatively, the walls may be conical or rectilinear in cross-section.

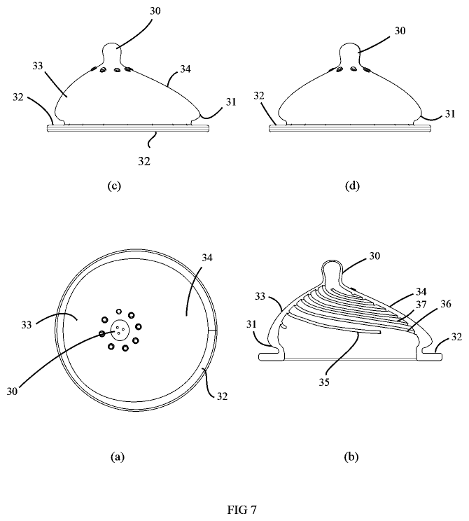

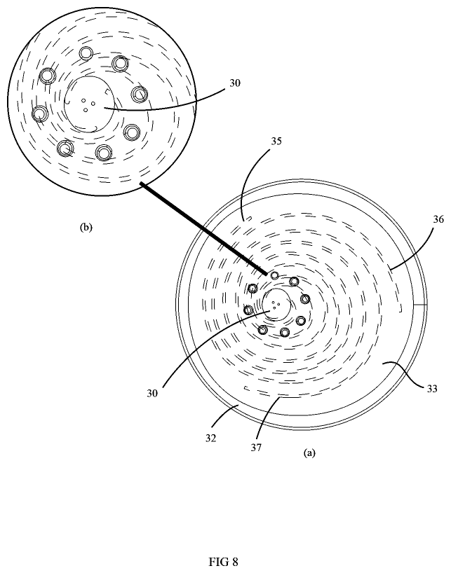

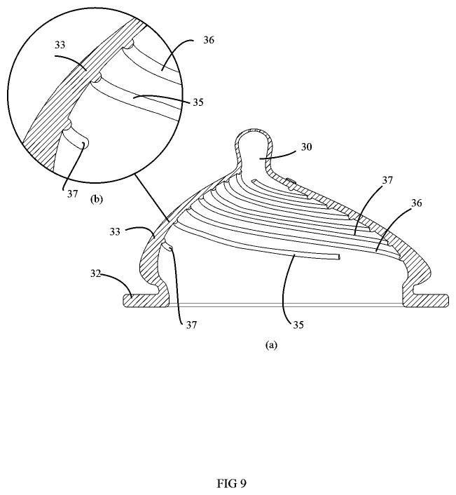

FIGS. 7(a-d), FIGS. 8(a-b) and FIGS. 9(a-b) have features which are generally similar to those of the embodiments shown in FIGS. 1 to 3. The location of the nipple (30) is displaced from the axis toward the lower part of the body (31) and annular flange (3) when the bottle and teat are tilted (anticlockwise as shown) during use. The location of the nipple (30) is displaced from the axis of the lower part of the body (31) and annular flange (32). In use the lower side (33) of the body (left hand side as shown in FIG. 7(b)). has a greater curvature than the upper side (34) so that the teat more closely resembles the natural shape of a mother's breast.

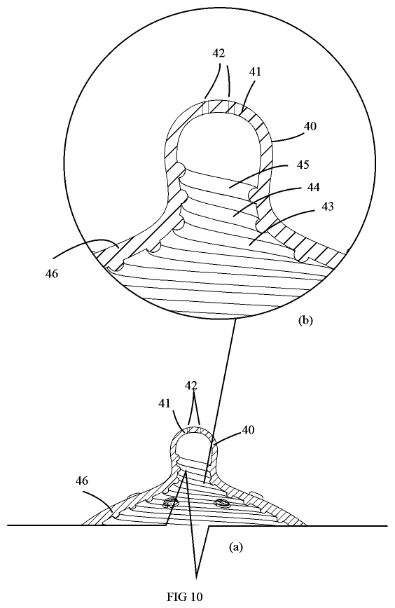

As shown in detail in FIGS. 8 and 9, the projections (35), (36), (37) are arranged with the spacing between adjacent projections being reduced on the lower side. FIG. 10a and b shows a further teat in accordance with this invention. The nipple (40) has a similar construction to that of FIGS. 1 to 3, including a domed upper part (41) and outlet ducts (42).

Spiral projections (43), (44), (45) extend from the inner surface of the body (46) into the interior of nipple (40) to provide reinforcement of a lower part of the nipple but leaving a softer end (41).

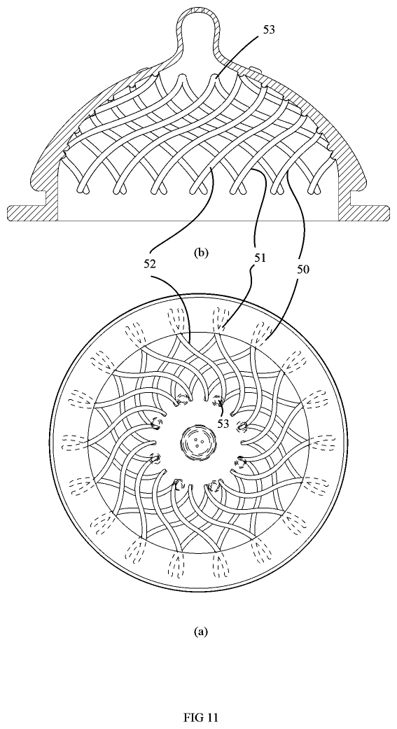

FIGS. 11(a-b) are a view from underneath and a vertical cross section of a further teat in accordance with this invention. The configuration is generally similar to that described with reference to FIGS. 1 to 3 except that the strengthening members (50), (51), (52) comprise overlapping sinusoidal ribs arranged to form an axially symmetrical pattern or array. The direction of each rib reverses at the upper, proximal end, e.g. (53). The density of the ribs decreases from the proximal end towards the lower, distal end as shown particularly in FIG. 11a.

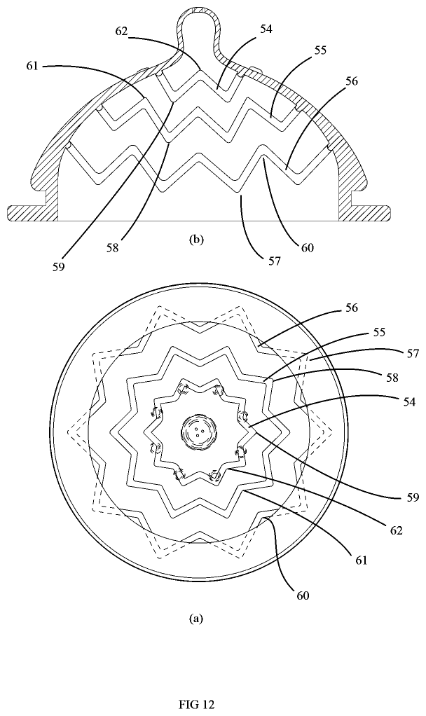

FIGS. 12(a-b) are a view from underneath and a vertical cross section of a further teat in accordance with this invention. The arrangement is generally similar to that shown in FIGS. 1 to 3 except that an array of concentric, alternating or zig zag ribs (54), (55), (56) extend around the central axis of the teat to form a generally star shaped pattern with outwardly extending points (57), (58) and (59) alternating with inwardly extending points (60), (61), (62) to provide uniform strengthening of the teat.

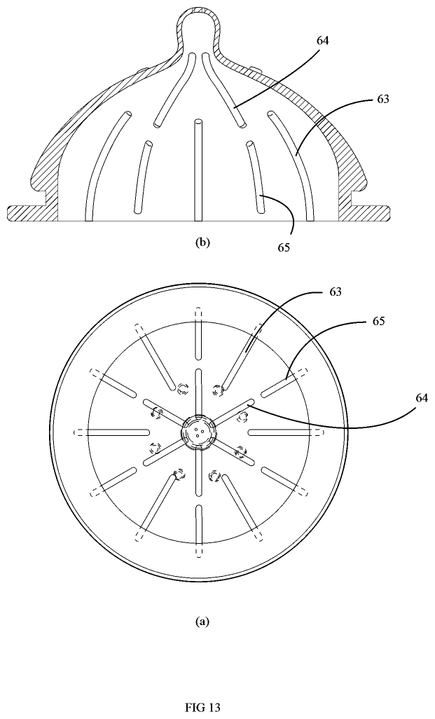

FIGS. 13(a-b) show a further embodiment similar to that of FIGS. 1 to 3 but having intermittent ribs (63), (64), (65) extending in a plane parallel to the central axis.

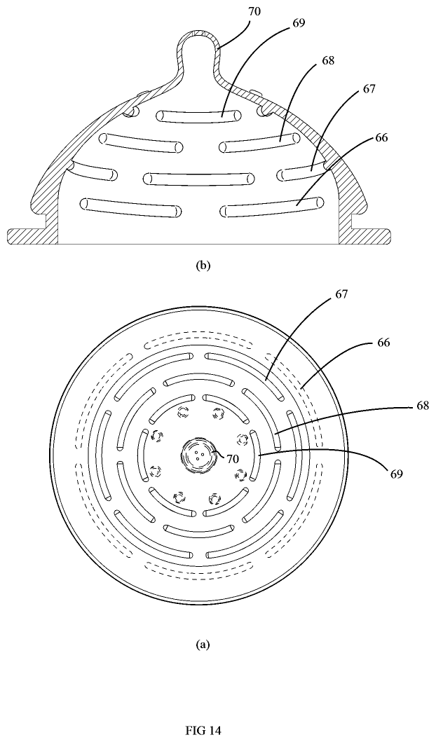

FIGS. 14(a-b) show a further embodiment similar to that shown in FIGS. 1 to 3, wherein intermittent ribs (66), (67), (68) and (69) extend in circular formations, each at a constant distance from the nipple (70) to form an array of concentric part circular ribs.

1. A feeding bottle teat comprising:
a body having an interior cavity and an exterior surface;
an inlet including a flange for engagement within an aperture of a feeding bottle cap in use; and
a nipple including one or more outlet apertures wherein the flange, the cavity, the nipple, the aperture of the feeding bottle cap and the one or more outlet apertures of the nipple apertures form a passageway for delivery of milk from the bottle in use;
wherein a transverse dimension of an interior surface of the body at the inlet is greater than a transverse dimension of the interior surface at the nipple; and
wherein the interior surface includes a plurality of concentric strengthening formations extending inwardly from the inner surface between the inlet and the nipple;
wherein the strengthening formations comprise coaxial concentric spirals which rotate about a common central axis; and
wherein each strengthening member comprises a spiral having two to four rotations about the central axis.

2. The feeding bottle teat as claimed in claim 1, wherein the common central axis extends through a center of the nipple and a center of the circular flange.

3. The feeding bottle teat as claimed in claim 1, wherein each strengthening member comprises a spiral having three rotations.

4. The feeding bottle teat as claimed in claim 1, wherein a pattern of strengthening members is denser in a region of the inner surface adjacent the nipple.

5. The feeding bottle teat as claimed in claim 1, wherein the strengthening formations are equidistantly located around the inner surface adjacent the inlet and/or nipple.

6. The feeding bottle teat as claimed in claim 1, wherein the strengthening formations are independently continuous or intermittent.

7. The feeding bottle teat as claimed in claim 1, wherein two to five formations are provided.

8. The feeding bottle teat as claimed in claim 7, wherein three strengthening formations are provided.

9. The feeding bottle teat as claimed in claim 1, wherein the strengthening formations comprise spirals located symmetrically about the nipple.

10. The feeding bottle teat as claimed in claim 1, wherein the strengthening formations are equally spaced from each adjacent spiral.

11. The feeding bottle teat as claimed in claim 1, wherein the separation between adjacent strengthening members decreases from a vicinity of the inlet towards a vicinity of the nipple.

12. The feeding bottle teat as claimed in claim 1, wherein the strengthening members comprise an odd number of spirals.

13. The feeding bottle teat as claimed in claim 12, wherein the strengthening members comprise between three and five spirals.

14. The feeding bottle teat as claimed in claim 1, wherein the exterior of the body is axially symmetrical and coaxial with the flange.

15. The feeding bottle teat as claimed in claim 1, wherein the nipple is offset from the axis of the flange.

16. The feeding bottle teat as claimed in claim 1, wherein the nipple comprises a plurality of outlet apertures.

17. The feeding bottle teat as claimed in claim 1, wherein the strengthening formations extend into the interior of the nipple.
